(19) United States
(12) Patent Application Publication
(10) Pub. No.: US 2026/0337303 A1
(43) Pub. Date: Oct. 29, 2026

(54) METHOD FOR CROSSLINKING POLYSACCHARIDES FROM MACROALGAE TO FORM A POLYMER MATERIAL

(71) Applicant: SEA6 TECHNOLOGIES EUROPE B.V., Utrecht (NL)

(72) Inventor: Ludwig Schmidtchen, Dresden (DE)

(73) Assignee: SEA6 TECHNOLOGIES EUROPE B.V., Utrecht (NL)

(21) Appl. No.: 19/099,767

(22) PCT Filed: Aug. 1, 2023
(86) PCT No.: PCT/EP2023/071254

§ 371 Date: Jan. 30, 2025

(30) Foreign Application Priority Data
Aug. 3, 2022 (EP) 22188418.2

(51) Int. Cl. C08B 37/00; C08J 5/18

(52) U.S. Cl. CPC C08B 37/0042; C08J 5/18; C08J 2305/00

(57) ABSTRACT

The invention relates to a method (1) for producing a polymer material, comprising the following steps (11, 12, 13): providing carrageenan-containing macroalgae (7); adjusting the weight average of the molecular weight of the carrageenan to less than 800 000 g/mol; supplying the macroalgae (7) into a processing chamber (4); and processing the macroalgae (7) to form a polymer material in the process chamber (4). The present invention also relates to a method (2) for producing a bioplastics product in a device (3) comprising a process chamber (4) and a shaping device (10), comprising the following steps (11, 12, 13, 14, 15, 16): producing a polymer material from carrageenan-containing macroalgae (7) in the process chamber (4); and shaping the polymer material in the shaping device (10) to form a bioplastics product. The present invention also relates to a bioplastics product obtained according to the method (2).

### TECHNICAL FIELD

The present invention relates to a method for producing a polymer material from carrageenan-containing macroalgae. Furthermore, the invention relates to a method for producing a bioplastic product from such a polymer material in a device comprising a process chamber and at least one shaping device. The invention also relates to a corresponding bioplastic product.

### BACKGROUND OF THE INVENTION

Some methods for producing polymer materials from polysaccharides from macroalgae and for producing bioplastic products therefrom are known from the prior art, in particular as molding process or extrusion process. An extrusion process for encapsulating a liquid is, for example, known from WO 2018/172781 A1 and WO 2020/065270 A1, and a compression molding process is further known from US 2017/0266847 A1.

Bioplastic products have major advantages over plastic products made from fossil raw materials, in particular, bioplastic products do not release fossil carbon dioxide and they are biodegradable. However, the problem with the known production methods for macroalgae-based bioplastic products is that the macroalgae from which the polysaccharides are obtained are subject to natural fluctuations in their properties. Therefore, continuous production of such bioplastic products with consistent process parameters and consistent product quality cannot be achieved in a satisfactory manner, so that industrial production of macroalgae-based bioplastic products has not yet been successful.

### DESCRIPTION OF THE INVENTION

Based on this situation, it is an object of the present invention to propose a method that enables a continuous and simple production of macroalgae-based bioplastic products.

The object of the invention is achieved by the features of the independent main claims. Advantageous embodiments are provided in the subclaims. If technically possible, the teachings of the subclaims can be combined as desired with the teachings of the main and subclaims.

The advantages of the claimed aspects of the invention are explained below and further below preferred modified embodiments of the aspects of the invention are described. Explanations, in particular with respect to advantages and definitions of features are basically descriptive and preferred, but not limiting, examples. If an explanation is limiting, this is explicitly mentioned.

According to a first aspect of the invention, the object is achieved by a method for producing a polymer material, comprising the steps of: providing carrageenan-containing macroalgae, adjusting the weight average of the molecular weight of the carrageenan to less than 800,000 g/mol, supplying the macroalgae to a process chamber and processing the macroalgae to form a polymer material in the process chamber.

Insofar as elements are designated by means of numbering, for example “first element”, “second element” and “third element”, this numbering is intended purely for differentiation in the designation and does not represent any dependency of the elements on each other or a mandatory sequence of the elements. This means in particular that, for example, a device or a process does not have to comprise a “first element” in order to be able to comprise a “second element”. Moreover, the device can also comprise a “first element” as well as a “third element”, without necessarily comprising a “second element”. It is also possible to provide several units of an element with a single numbering, for example several “first elements”.

A polymer material is understood to mean a material that is at least partially formed from macromolecules, in particular from cross-linked macromolecules, and is suitable for further processing into a plastic product. A plastic product is understood to mean a polymer material which is brought into a certain product form. In particular, a plastic product is subsequently provided with the desired material properties after shaping, for example by drying and cooling the plastic product. Insofar as the plastic product has the prefix “bio”, it is a plastic product made purely from biodegradable materials. In particular, a bioplastic product is made purely from a polymer material based on polysaccharides from macroalgae and is completely biodegradable in its entirety.

A process chamber is formed by a cavity, which can be filled via inlets, for example, and emptied via outlets, for example, wherein inlets and outlets may also coincide. In particular, a process chamber is, for example, a closed cavity into which the macroalgae and optionally other feedstock are initially introduced and the cavity is then closed. However, the process chamber is preferably a process chamber with one or more inlets and one or more outlets, in which the process can be carried out continuously. The inlet(s) and outlet(s) are then sealed, for example, by the inflowing feedstocks or the outflowing polymer material, so that the inside of the process chamber can be pressurized to a level higher than that of the environment. In or at a process chamber, in particular means for controlling the temperature and pressure prevailing in the process chamber are provided.

The macroalgae have a certain natural proportion of carrageenan, which forms the polymer structure of the polymer material or bioplastics and for this purpose forms compounds and/or cross-links during production. The macroalgae are preferably dried and crushed for the process, wherein the macroalgae particles thus obtained are mechanically, chemically and/or thermally bonded and/or cross-linked during the process to form the polymer material or bioplastic product. For example, red algae such as Kappaphycus Alvarezii or Euchema Denticulatum are used as macroalgae.

The molecular weight of a macromolecule, also called molecular mass, is the sum of the molar masses of the repeating structural units. The molar mass of the structural units is composed of the sum of the atomic masses of which the structural unit consists. Polymers do not have an exact molecular weight, but a molecular weight distribution that allows for various average values, such as the number-average M̅ₙ of the molecular weight or the weight-average M̅_{w} of the molecular weight. The weight-average M̅_{w} of the molecular weight is given by

$${\overline{M}}_{w} = \sum {w}_{i} {M}_{i}$$

wherein wᵢ is the weight fraction of the polymer molecules that consist of i monomer units, wᵢ thus describes the ratio of the weight NᵢMᵢ of the polymer molecules to the total mass of all polymer molecules ΣNᵢMᵢ

$${w}_{i} = \frac{{N}_{i} {M}_{i}}{\sum {N}_{i} {M}_{i}}$$

Measured molar masses of a macromolecule therefore always represent an average value.

The weight average of the molecular weight of carrageenan is in particular determined by gel permeation chromatography, in particular after extraction of the carrageenan from the macroalgae. The determination comprises in particular the following steps: (a) providing a 1% acetic acid/sodium acetate buffer with a pH of 7.5-8.0, (b) adding about 1.5% carrageenan-containing material, (c) extracting the carrageenan at 95 °C for 1-2 hours with a slow-running blender, (d) filtration with a filter cloth and a layer of filter aid on the top by use of a suction filter, (e) cooling to below 50 °C after filtration, (f) coagulation of the carrageenan with 2-3 parts isopropyl alcohol and (g) drying the carrageenan at or below 60 °C.

The first aspect of the invention now includes the teaching that the molecular weight is used as a factor by means of which the macroalgae are qualified for the production of the polymer material. This is based on the surprising finding that, by maintaining the weight average of the molecular weight of the carrageenan contained at less than 800,000 g/mol while keeping the process parameters constant, consistent properties of the polymer material are obtained, which enable the production of bioplastic products in a continuous process and with consistent properties and consistent product quality, wherein the macroalgae are used in their entirety as the feedstock. Consequently, consistent material properties of the polymer material can be achieved, although a natural raw material is used that is correspondingly subject to natural fluctuations in its properties. In the continuously executed process, the macroalgae are therefore permanently and consistently supplied with the adjusted weight average of the molecular weight of the carrageenan of less than 800,000 g/mol. The method according to the first aspect of the invention then enables the continuous industrial production of macroalgae-based polymer materials or bioplastic products in a particularly advantageous way. In particular, the polymer material produced by means of the method according to the first aspect of the invention can be shaped as desired by means of various reshaping processes, so that a wide range of applications is established.

A usual weight average of the molecular weight for polysaccharides naturally occurring in macroalgae varies greatly for different macroalgae and lies, for example, in a range between 200,000 g/mol and 1,300,000 g/mol. Values of up to 2,000,000 g/mol are also known from literature for certain polysaccharides or certain macroalgae. In particular, the molecular weight of a polysaccharide occurring in a certain macroalga can vary significantly. The method according to the first aspect of the invention comprises in this regard the teaching to adjust the weight average of the molecular weight in the macroalgae.

In the process chamber, the macroalgae are preferably mixed with a liquid, in particular water, in a ratio of liquid to solid between 3:1 and 1:9 for processing, wherein furthermore in the process chamber at least the vapor pressure of water at a first temperature greater than or equal to 100° Celsius acts on the mixture and the mixture is adjusted to the first temperature.

The method preferably includes a further step, namely determining the weight average of the molecular weight, in particular by means of gel permeation chromatography, for example by means of the steps of gel permeation chromatography described above or by means of an indirect method, before the macroalgae are supplied into the process chamber. The additional step is preferably carried out after adjusting or during adjusting the weight average of the molecular weight. In this way, the adjusted weight average of the molecular weight of the carrageenan is verified and secured. In one embodiment, the verification and securing can be carried out by means of an indirect method, so that the determination can be carried out in a sufficiently short time in order to process a large amount of macroalgae during a continuous operation of the method.

Preferably, the macroalgae are processed to form a polymer material in the process chamber by means of physical cross-linking of the carrageenan. Physical cross-linking can be caused by various parameters, in particular as hydrogel formation. The entanglement or interlocking of the macromolecules, which can be influenced by the concentration of the polymer in solution and the molecular weight, is only one method for gelation. Other methods of physical cross-linking are based, for example, on hydrogen bridge bonds, hydrophobic, hydrophilic, ionic interactions (COULOMB forces), complex formation or the formation of crystalline structures. This form of gel formation is reversible. k-carrageenan or I-carrageenan, as well as other polysaccharides, form hydrogels in aqueous solution by formation of intra- and intermolecular bonds, in which hemiacetal oxygen, hydroxyl or methyl groups of the sugar residues of the polysaccharides contribute to hydrogen bridge bonds or van der Waals bonds. The sulfuric acid and carboxyl groups of the sugar residues of certain acidic polysaccharides, e.g. k-carrageenan, l-carrageenan or alginate, are also involved in intra- and/or intermolecular associations through monovalent or divalent cations, which exhibit ionic bonds or electrostatic forces of attraction.

Depending on the molecular weight, polysaccharides can be processed, in particular physically cross-linked, with varying degrees of processability at certain process parameters and in certain devices for carrying out a method, wherein in particular the resulting polymer material has different properties depending on the molecular weight of the polysaccharides. The properties of the polymer material should be such that the polymer material can be easily processed in the given device with given process parameters and can be processed into a bioplastic product with advantageous properties for a specific application. The weight average of the molecular weight of the carrageenan of the macroalgae is therefore preferably determined depending on the process parameters, the device and the desired properties of a resulting bioplastic product and adjusted accordingly. Relevant properties of the polymer material are, for example, its rheological and chemical properties. Relevant properties of a bioplastic product are, in particular, mechanical properties such as toughness and strength, as well as, for example, its chemical resistance. For example, the weight average of the molecular weight of the carrageenan used to provide the macroalgae is adjusted to less than 800,000 g/mol, less than 790,000 g/mol, less than 780,000 g/mol, less than 770,000 g/mol, less than 760,000 g/mol, less than 750,000 g/mol, less than 740,000 g/mol, less than 730,000 g/mol, less than 720,000 g/mol, less than 710,000 g/mol, less than 700,000 g/mol, less than 690,000 g/mol, less than 680,000 g/mol, less than 670,000 g/mol, less than 660,000 g/mol, less than 650,000 g/mol, less than 640,000 g/mol, less than 630,000 g/mol, less than 620,000 g/mol, less than 610,000 g/mol, less than 600,000 g/mol, less than 590,000 g/mol, less than 580,000 g/mol, less than 570,000 g/mol, less than 560,000 g/mol, less than 550,000 g/mol, less than 540,000 g/mol, less than 530,000 g/mol, less than 520,000 g/mol, less than 510,000 g/mol, less than 500,000 g/mol, less than 490,000 g/mol, less than 480,000 g/mol, less than 470,000 g/mol, less than 460,000 g/mol, less than 450,000 g/mol, less than 440,000 g/mol, less than 430,000 g/mol, less than 420,000 g/mol, less than 410,000 g/mol, less than 400,000 g/mol, less than 390,000 g/mol, less than 380,000 g/mol, less than 370,000 g/mol, less than 360,000 g/mol, less than 350,000 g/mol, less than 340,000 g/mol, less than 330,000 g/mol, less than 320,000 g/mol, less than 310,000 g/mol, less than 300,000 g/mol, less than 290,000 g/mol, less than 280,000 g/mol, less than 270,000 g/mol, less than 260,000 g/mol, less than 250,000 g/mol, less than 240,000 g/mol, less than 230,000 g/mol, less than 220,000 g/mol, less than 210,000 g/mol, less than 200,000 g/mol, less than 190,000 g/mol, less than 180,000 g/mol, less than 170,000 g/mol, less than 160,000 g/mol, less than 150,000 g/mol, less than 140,000 g/mol, less than 130,000 g/mol, less than 120,000 g/mol, less than 110,000 g/mol, less than 100,000 g/mol, less than 90,000 g/mol, less than 80,000 g/mol, less than 70,000 g/mol, less than 60,000 g/mol or less than 50,000 g/mol.

Furthermore, the weight average of the molecular weight of the carrageenan for providing the macroalgae is preferably adjusted to be more than 1,000 g/mol, more than 10,000 g/mol, more than 20,000 g/mol, more than 30,000 g/mol, more than 40,000 g/mol, more than 50,000 g/mol, more than 60,000 g/mol, more than 70,000 g/mol, more than 80,000 g/mol, more than 90,000 g/mol or more than 100,000 g/mol.

The weight average of the molecular weight of the carrageenan is determined in the case of macroalgae, for example, by a mechanical method, a thermal method, a chemical method, an enzymatic method, an aerobic and/or anaerobic biological method, by radiation and/or by ultrasound. The macroalgae are preferably treated enzymatically to adjust the weight average of molecular weight of the carrageenan, tempered and/or stored.

Carrageenan-containing macroalgae are particularly suitable for the present method because they have favorable properties for, in addition to processing, in particular physical cross-linking, being conveyed into the process chamber, for example towards a shaping device, and also for having favorable material properties for a bioplastic product. The macroalgae may also contain other substances in addition to carrageenan.

In a preferred embodiment, at least one second feedstock, in particular a liquid containing water, is supplied into the process chamber in addition to the macroalgae. For example, the liquid is essentially formed from water and may also contain other substances. In particular, the liquid may also contain solids which, for example, are or become liquid at the temperature and pressure prevailing in the process chamber. It is also within the scope of the invention if the macroalgae and other feedstocks, such as the second feedstock, are added at different times during the method. The second feedstock can be designed for various process-related functions, such as improved rheological properties or improved solubility of the carrageenan, or to achieve a certain property of the polymer material or a bioplastic product made therefrom, for example a certain mechanical property. Particularly preferably, the second feedstock comprises water and at least one additive, such as a solvent and/or a plasticizer, in order to achieve a good solution of the carrageenan and good mechanical properties of a bioplastic product made from the polymer material.

An additive in the form of a solvent has preferably a high polarity. In this way, good overall solubility of the polar carrageenan can be achieved.

Further preferably, the additive is non-volatile. In particular, an additive in the form of a plasticizer is non-volatile. The additive then remains in the bioplastic product during and after drying and cooling of a bioplastic product and does not evaporate. This applies in particular to expected conditions of use or transport, in particular an expected temperature of use or transport of the bioplastic product, for example at an ambient temperature of up to 80° Celsius. Such a temperature can prevail, for example, in a transport container under solar radiation.

In a preferred embodiment, the at least one additive comprises glycerol and/or sorbitol. In further embodiments, at least one additive is formed by pentaerythritol, polyol, sugar alcohol, poly (oxyethylene), poly (oxypropylene), non-ionic surfactants and/or anionic surfactants, which respectively act in particular as plasticizers in a bioplastic product. Further preferred additives, which act in particular as solvents, are glycols, for example ethylene glycol or diethylene glycol, methanol, ethanol, maltodextrin and/or urea. The following may also be used as additives: 1,3-butylene glycol, acetic and fatty acid esters of glycerol, acetone, acetylated distarch adipate, acetylated monoglycerides, acid-treated starch, alkali-treated starch, ascorbic acid, palmitic acid ascorbyl ester, ascorbyl stearate, azodicarboxamide, beeswax, bleached starch, bone phosphate, brominated vegetable oil, calcium acetate, calcium aluminum silicate, vegetable oils, calcium ascorbate, calcium benzoate, calcium bromate, calcium carbonates, calcium chloride, calcium citrate, calcium dihydrogen phosphate, calcium ferrocyanide, calcium gluconate, calcium hydrogen sulfite, calcium hydroxide, calcium iodate, calcium lactate, calcium lactate gluconate, calcium lactobionate, sucrose, calcium peroxide, calcium phosphate, calcium polyphosphate, calcium salts of fatty acids, calcium silicate, calcium sorbate, calcium stearate, calcium stearoyl lactylate, calcium sulfate, calcium tartrate, soy protein, calcium iodate, candelilla wax, carnauba wax, locust bean gum, castor oil, citric acid, pea protein, citric acid and fatty acid esters of glyceroine, cross-linked sodium carboxymethylcellulose, carboxymethylcellulose, copper sulfate of monound diglycerides of fatty acids, diammonium hydrogen phosphate, dicalcium pyrophosphate, diethylpyrocarbonate, ethyl alcohol, ethyl cellulose, ethylhydroxyethyl cellulose, esters of glycerine and thermally oxidized soy fatty acids, zein, ethoxylated mono- and diglycerides, ethylhydroxyethyl cellulose, formic acid, gelatin, glycerin, guar gum, gum arabicum, peroxide derivatives, hydrogen peroxide, hydroxylated lecithin, hydroxypropyl cellulose, hydroxypropyl distarch, cellulose derivatives.

According to a second aspect of the invention, the object is achieved by a method for producing a bioplastic product in a device comprising a process chamber and at least one shaping device, comprising the steps of: producing a polymer material from carrageenan-containing macroalgae in the process chamber according to a prescribed method and shaping the polymer material in the at least one shaping device to form a bioplastic product. In this case, the shaping can, for example, in the case of a molding process, take place simultaneously with or prior to the cross-linking in a process chamber designed as a mold, or, for example, in an extrusion process after the cross-linking. With the method according to the second aspect of the invention, the advantages already described with regard to the first aspect of the invention are achieved accordingly. In particular the method is suited to produce a bioplastic product with consistent properties or consistent product quality in a continuous process.

The method according to the second aspect of the invention further optionally comprises the steps of drying the bioplastic product and/or cooling the bioplastic product. Here, the drying and/or cooling of the bioplastic product is optional in that it is only carried out or must be carried out if, after shaping, a corresponding residual moisture and/or temperature is present in the bioplastic product, i.e. when the residual moisture and/or temperature is higher than desired.

The process chamber in the method according to the second aspect of the invention can, for example, be formed by a simple cavity in which the method is carried out in batches. In a preferred embodiment, the process chamber is formed by a screw extruder. It is particularly preferred that the screw extruder is formed as a twin-screw extruder. In a screw extruder, one or more parallel screws extend through a channel and draw in the macroalgae or feedstocks at the inlet side and push them at the outlet side into or through a shaping device. Preferably, several feedstocks are mixed in the screw extruder. Here, the geometry of the screw(s) and the operating parameters of the screw extruder can be used to determine the conveying capacity of the screw extruder and the pressure prevailing in the process chamber. The pressure can preferably escape from the process chamber neither at the inlet side nor at the outlet side, since the inlet and the outlet are sealed by the macroalgae/the feedstocks and the polymer material.

It is particularly preferred that the at least one shaping device is formed by an extrusion nozzle. By use of an extrusion nozzle, a polymer material emerging from a process chamber can be continuously shaped into an endless form, for example into a film, a semifinished product for a film or a profile. An optional drying and cooling process following the shaping step can then take place, for example, under ambient conditions, wherein the residual heat of the bioplastic product can be used to dry the bioplastic product. In a further embodiment, the at least one shaping device is formed by an injection molding device. It is then possible to produce bioplastic products with comparatively complex geometries by use of the polymer material by means of injection molding.

The object is achieved according to a third aspect of the invention with a bioplastic product obtained by a method according to the second aspect of the invention. The bioplastic product has the advantages of the first and the second aspect of the invention accordingly. In particular, the bioplastic product has consistent properties and consistent product quality, is fully biodegradable and can be produced in comparatively complex geometries.

In particular, the bioplastic product is characterized in that, like the macroalgae, it has a weight average of the molecular weight of the polymer molecules. In one embodiment, the bioplastic product has a molecular weight of less than 700,000 g/mol, less than 690,000 g/mol, less than 680,000 g/mol, less than 670,000 g/mol, less than 660,000 g/mol, less than 650,000 g/mol, less than 640,000 g/mol, less than 630,000 g/mol, less than 620,000 g/mol, less than 610,000 g/mol, less than 600,000 g/mol, less than 590,000 g/mol, less than 580,000 g/mol, less than 570,000 g/mol, less than 560,000 g/mol, less than 550,000 g/mol, less than 540,000 g/mol, less than 530,000 g/mol, less than 520,000 g/mol, less than 510,000 g/mol, less than 500,000 g/mol, less than 490,000 g/mol, less than 480,000 g/mol, less than 470,000 g/mol, less than 460,000 g/mol, less 450,000 g/mol, less than 440,000 g/mol, less than 430,000 g/mol, less than 420,000 g/mol, less than 410,000 g/mol, less than 400,000 g/mol, less than 390,000 g/mol, less than 380,000 g/mol, less than 370,000 g/mol, less than 360,000 g/mol, less than 350,000 g/mol, less than 340,000 g/mol, less than 330,000 g/mol, less than 320,000 g/mol, less than 310,000 g/mol, less than 300,000 g/mol, less than 290,000 g/mol, less than 280,000 g/mol, less than 270,000 g/mol, less than 260,000 g/mol, less than 250,000 g/mol, less than 240,000 g/mol, less than 230,000 g/mol, less than 220,000 g/mol, less than 210,000 g/mol, less than 200,000 g/mol, less than 190,000 g/mol, less than 180,000 g/mol, less than 170,000 g/mol, less than 160,000 g/mol, less than 150,000 g/mol, less than 140,000 g/mol, less than 130,000 g/mol, less than 120,000 g/mol, less than 110,000 g/mol, less than 100,000 g/mol, less than 90,000 g/mol, less than 80,000 g/mol, less than 70, 00 g/mol, less than 60,000 g/mol, less than 50,000 g/mol, less than 40,000 g/mol, less than 30,000 g/mol, less than 20,000 g/mol or less than 10,000 g/mol.

Further preferably, the bioplastic product is formed as a film, as a semi-finished product for a film or as a profile. With such bioplastic products the advantages of the method according to the second aspect of the invention are particularly achieved. In particular, such bioplastic products require the adjustment of product properties within narrow limits and with consistent quality. For example, in the case of a film, a local deviation in product quality at one point of the film would result in an increased risk of cracking at that point. Furthermore, the bioplastic product is particularly preferably extruded.

### BRIEF DESCRIPTION OF THE DRAWINGS

The invention is explained in more detail below with reference to the accompanying drawings on the basis of preferred exemplary embodiments. The phrase “Figure” is abbreviated as “Fig.” in the drawings.

In the drawings:

FIG. 1 shows a schematic flow diagram of a method according to the first aspect of the invention;

FIG. 2 shows a schematic flow diagram of a method according to the second aspect of the invention; and

FIG. 3 shows a schematic sectional view of a device for carrying out a method according to the first and/or second aspect of the invention.

### DETAILED DESCRIPTION OF THE DRAWINGS

The described exemplary embodiments are only examples that can be modified and/or supplemented in a variety of ways within the scope of the claims. Each feature described for a particular exemplary embodiment can be used independently or in combination with other features in any other exemplary embodiment. Each feature described for an exemplary embodiment of a particular claim category can also be used in a corresponding manner in an exemplary embodiment of a different claim category.

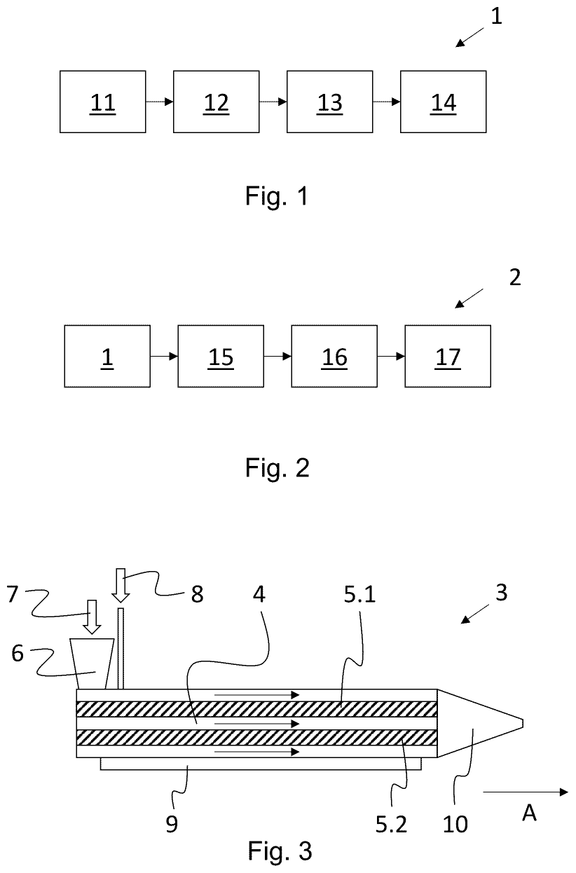

FIG. 1 shows a method 1 according to the first aspect of the invention for producing a polymer material from carrageenan-containing macroalgae in a process chamber. In a first step 11, the carrageenan-containing macroalgae are provided. In a second step 12, the macroalgae are adjusted to a weight average of the molecular weight of the carrageenan of less than 800,000 g/mol in order to achieve that the macroalgae can be processed in the following steps with consistent properties and consistent product quality. In a third step 13, the macroalgae are supplied into the process chamber. In particular, further feedstocks, such as liquids with water and additives for improving the process conditions in the process chamber and/or the properties of the first feedstock and/or an (intermediate) product thereof, are supplied into the process chamber. In a fourth step 14, the macroalgae in the process chamber are processed, in particular by means of physical cross-linking of the carrageenan, to form a polymer material. The third step 13 and the fourth step 14 can be carried out subsequently or simultaneously, or they can merge smoothly into one another.

FIG. 2 shows a method 2 according to the second aspect of the invention for producing a bioplastic product in a device comprising a process chamber and a shaping device. The method 2 initially comprises the method 1, in which a polymer material is produced in the process chamber, in particular by means of physical cross-linking of the carrageenan. This is followed by a fifth step 15 in which the polymer material is shaped in the shaping device to form a bioplastic product. The shaping device may, for example, be an extrusion nozzle or an injection molding device. In an optional sixth step 16, the bioplastic product is dried, while in a likewise optional seventh step 17 the bioplastic product is cooled. The sixth step 16 and the seventh step 17 can be carried out simultaneously, wherein the residual heat, which is dissipated by the cooling, can also be used to dry the bioplastic product.

FIG. 3 shows a device 3 for carrying out a method 1 according to the first aspect of the invention and/or a method 2 according to the second aspect of the invention. The device 3 is designed as a twin-screw extruder and comprises a process chamber 4 in which two screws 5.1, 5.2 are arranged on parallel axes of rotation. The screws 5.1, 5.2 are shown in a greatly simplified form, but comprise non-shown windings with geometries that are matched to one another, so that the screws 5.1, 5.2 exert pressure on a medium disposed in the process chamber 4 during rotation and also cause the medium to be mixed and conveyed in an axial direction A.

Carrageenan-containing macroalgae 7 are introduced into the process chamber 4 via a funnel 6, and a second feedstock 8, which is in particular in the form of a liquid and contains at least one additive in addition to water, is introduced via a hose. The second feedstock 8 serves in particular to ensure that the carrageenan can be dissolved at least partially therein. The macroalgae 7 and the second feedstock 8 are mixed in the process chamber 4 by means of the screws 5.1, 5.2. The resulting mixture is conveyed along the process chamber 4 in the axial direction A, while being further mixed and pressurized. Furthermore, the mixture is tempered by use of tempering means 9 to a process temperature. Moreover, heat energy is introduced by the mechanical work that the screws 5.1, 5.2 perform on the mixture. Overall, during the passage through the process chamber 4, a physical cross-linking of the carrageenan takes place in the mixture, so that the macroalgae 7 are processed to form a polymer material.

At an end-side outlet of the process chamber 4 in the axial direction A a shaping device 10 is arranged, through which the polymer material is pushed. The shaping device 10 is, for example, configured as an extrusion nozzle, wherein at the extrusion nozzle a shaping extrusion into a desired geometry, for example into the geometry of a profile, a film or a semi-finished product for a film, takes place. Downstream of the extrusion nozzle, for example, a cooling and drying section, not shown in more detail, is provided, via which a bioplastic product formed at the extrusion nozzle can be cooled and/or dried. The shaping device 10 can also be designed as an injection nozzle for injecting the polymer material into an injection molding die. A bioplastic product formed by injection molding is then, for example after molding, removed from the injection molding die and cooled and/or dried in the ambient air.

### LIST OF REFERENCE SYMBOLS

1 method
2 method
3 device
4 process chamber
5.1 screw
5.2 screw
6 funnel
7 carrageenan-containing macroalgae
8 second feedstock
9 tempering means
10 shaping device
11 first process step—providing macroalgae
12 second process step—adjusting the weight average of the molecular weight of the carrageenan
13 third process step—supplying the macroalgae into the process chamber
14 fourth process step—processing the macroalgae to form a polymer material
15 fifth process step—shaping the polymer material
16 sixth process step—drying the bioplastic product
17 seventh process step—cooling the bioplastic product
A axial direction

1. A method (1) for producing a polymer material, comprising the steps (11, 12, 13) of:
providing carrageenan-containing macroalgae (7);
adjusting the weight average of the molecular weight of the carrageenan to less than 800,000 g/mol;
supplying the macroalgae (7) into a process chamber (4); and
processing the macroalgae (7) to form a polymer material in the process chamber (4).

2. The method (1) according to claim 1, wherein the processing of the macroalgae (7) to form a polymer material in the process chamber (4) is carried out by physical cross-linking of the carrageenan.

3. The method (1) according to claim 1, wherein the weight average of the molecular weight of the carrageenan is determined before the macroalgae (7) are supplied into the process chamber (4), in particular by means of gel permeation chromatography after extraction of the carrageenan from the macroalgae (7) or by an indirect method.

4. The method according to claim 1, wherein the macroalgae (7) are adjusted to a weight average of the molecular weight of the carrageenan of less than 600,000 g/mol, in particular less than 400,000 g/mol.

5. The method (1) according to claim 1, wherein the macroalgae (7) are enzymatically treated, tempered, mixed and/or stored to adjust the weight average of the molecular weight of the carrageenan.

6. The method (1) according to claim 1, wherein at least a second feedstock (8), in particular a liquid containing water, is supplied into the process chamber (4) in addition to the macroalgae (7).

7. The method (1) according to claim 6, wherein the second feedstock (8) contains water and at least one additive, in particular a solvent and/or a plasticizer.

8. A method (2) for producing a bioplastic product in a device (3) comprising a process chamber (4) and at least one shaping device (10), comprising the steps (11, 12, 13, 14, 15, 16) of:
producing a polymer material from carrageenan-containing macroalgae (7) in the process chamber (4) according to the method (1) of claim 1;
shaping the polymer material in the shaping device (10) to form a bioplastic product;
optionally drying the bioplastic product; and
optionally cooling the bioplastic product.

9. The method (2) according to claim 8, wherein the process chamber (4) is formed by a screw extruder, in particular a twin-screw extruder.

10. The method (2) according to claim 8 of 9, wherein the at least one shaping device (10) is formed by an extrusion nozzle or an injection molding device.

11. The method (2) according to claim 8, wherein the method (2) is carried out continuously.

12. A bioplastic product obtained by a method (2) according to claim 8.

13. The bioplastic product according to claim 12, comprising a molecular weight of less than 700,000 g/mol.

14. The bioplastic product according to claim 12, formed as a film, as a semi-finished product for a film or as a profile.
